(19) United States
(12) Patent Application Publication
(10) Pub. No.: US 2025/0028899 A1
(43) Pub. Date: Jan. 23, 2025

(54) USER-BASED EXTRACTION OF CONTENT

(71) Applicant: Omnissa, LLC, Mountain View, CA (US)

(72) Inventors: ROHIT PRADEEP SHETTY, Bangalore (IN); Ravish Chawla, Atlanta, GA (US); Adam Chow, Atlanta, GA (US)

(21) Appl. No.: 18/380,219

(22) Filed: Oct. 16, 2023

(30) Foreign Application Priority Data
Jul. 20, 2023 (IN) 202341048787

(51) Int. Cl. G06F 40/197; G06F 40/166; H04L 51/42

(52) U.S. Cl. CPC G06F 40/197; G06F 40/166; H04L 51/42

(57) ABSTRACT

Disclosed are various embodiments for redacting or modifying content in documents that are provided to users. A user profile can be generated by analyzing user data within or external to the enterprise. A document can also be analyzed to identify or classify the document's components. A document or other content can be modified or redacted based upon the user profile and the analysis of the document.

### RELATED APPLICATIONS

Benefit is claimed under 35 U.S.C. 119 (a)-(d) to Foreign Application Serial No. 202341048787 filed in India entitled “USER-BASED EXTRACTION OF CONTENT”, on Jul. 20, 2023, by VMware, Inc., which is herein incorporated in its entirety by reference for all purposes.

### BACKGROUND

Users within an enterprise may have access to certain documents or other content. Users might wish to share or publish documents with other users within the enterprise or outside of the enterprise. Typical document sharing can be facilitated by email or file transfer services or protocols. Different users within an enterprise might have different levels of access to confidential or personally identifiable information based upon their role or access credentials associated with the enterprise.

For example, a user at an executive level might have access to certain types of content within an enterprise, whereas another user at a subordinate level might not have access to certain types of content within the enterprise. Accordingly, sharing a document or another type of content to these users can be made difficult because a document might contain content that the executive user is entitled to view but that the subordinate user is not entitled to view.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIG. 1 is a drawing of a networked environment according to various embodiments of the present disclosure.

FIGS. 2-4 are example user interfaces generated by a browser based upon a document representation of a document according to various embodiments of the present disclosure.

FIG. 5 is a flowchart illustrating one example of functionality implemented as portions of agent application executed in a computing environment in the networked environment of FIG. 1 according to various embodiments of the present disclosure.

### DETAILED DESCRIPTION

Users in an enterprise environment can be provided with access to documents via a mobile device, computer and/or other type of computing device or client device. Users may also wish to share documents with other users who are internal or external to the enterprise. In many cases, the entire contents of documents that are shared may not be relevant to all readers or recipients of a document. For example, some of the target audience might be interested in certain parts of the document while others in the target audience might be interested in completely different parts of the document. For example, a technical research paper might be interesting or relevant in its entirety to a development teach, whereas a product manager might only be interested in the abstract or an executive summary of the document.

Examples of the disclosure can generate a personalized representation of a document based upon a profile generated for users. The profile can be based upon various data and metrics that can be obtained about the user, such as demographic information, documents associated with the user in a document archive of the enterprise, a role of the user within an enterprise, a job title of a user, the reading history of the user, web browsing history of the user, content the user has authored, published, endorsed, or liked, calendar data of the user, emails the user has received or sent, and other profile data. A document presented to the user can be analyzed and classified by a document analysis process. Then a personalized presentation of a document can be generated and presented to the user. In the context of this disclosure, a document can also represent an email or other content that is distributed within or external to an enterprise.

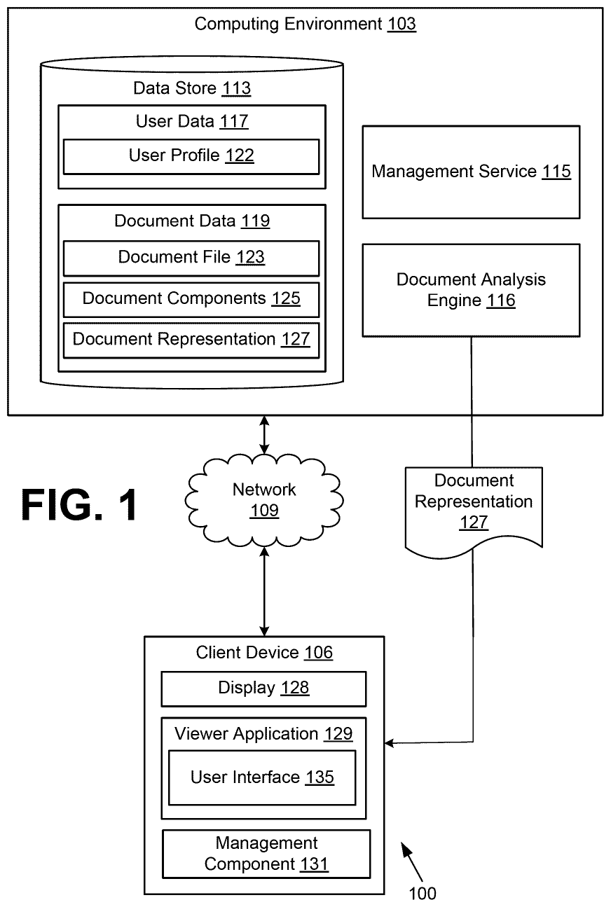

With reference to FIG. 1, shown is a networked environment 100 according to various embodiments. The networked environment 100 includes a computing environment 103 and a client device 106, and another client device 106, which are in data communication with each other via a network 109. The network 109 includes, for example, the Internet, one or more intranets, extranets, wide area networks (WANs), local area networks (LANs), wired networks, wireless networks, other suitable networks, or any combination of two or more such networks. For example, such networks may comprise satellite networks, cable networks, Ethernet networks, telephony networks, and other types of networks.

The computing environment 103 may comprise, for example, a server computer or any other system providing computing capability. Alternatively, the computing environment 103 may employ a plurality of computing devices that can be arranged, for example, in one or more server banks, computer banks or other arrangements. Such computing devices can be located in a single installation or can be distributed among many different geographical locations. For example, the computing environment 103 may include a plurality of computing devices that together may comprise a hosted computing resource, a grid computing resource and/or any other distributed computing arrangement. In some cases, the computing environment 103 may correspond to an elastic computing resource where the allotted capacity of processing, network, storage, or other computing-related resources may vary over time. The computing environment 103 may also include or correspond to one or more virtualized server instances that are created in order to execute the functionality that is described herein.

Various systems and/or other functionality can be executed in the computing environment 103 according to various embodiments. Also, various data is stored in a data store 113 that is accessible to the computing environment 103. The data store 113 can be representative of a plurality of data stores 113 as can be appreciated. The data stored in the data store 113, for example, is associated with the operation of the various applications and/or functional entities described below.

The components executed on the computing environment 103, for example, include a management service 115, a document analysis engine 116, and other applications, services, processes, systems, engines, or functionality not discussed in detail herein. The management service 115 can be executed to manage and/or oversee the operation of multiple client devices 106 that are enrolled within a device management framework facilitated by the management service 115. For example, an employer may operate the management service 115 to ensure that the client devices 106 of its employees are operating in compliance with various compliance rules. By ensuring that the client devices 106 of its employees are operated in compliance with the compliance rules, the employer may control and protect access to various data as well as the usage of devices that are potentially issued by the employer. The management service 115 may also facilitate access to email, calendar data, contact information, documents, or other enterprise data to which an enterprise may wish to provide access by users via client devices 106.

The computing environment 103 can also execute a document analysis engine 116 that can generate user profiles, perform a document analysis, and generate a personalized presentation of a document. The document analysis engine 116 can generate a user profile of users in the enterprise based on various user profile data. The user data 117 can include information about the user's role within an enterprise or hierarchy, reading habits of the user, browsing history of the user, authorship history of the user, the user's interests in other documents or contents, files and documents associated with the user in a document storage system, or other user data or user profile data. The document analysis engine 116 can receive or identify a document that is shared or accessed by the user and generate a classification of the document. The document can be tagged by identifying sections of the document based upon its content. For example, the document analysis engine 116 can identify an introduction, abstract, summary, body, conclusion, or other parts of a document. The various parts of the document can be tagged by the document analysis engine 116.

The document analysis engine 116 can also generate a personalized presentation of a document based upon the user profile of the user and the analysis of the document itself. Whenever the user attempts to access the document, the document can be provided with a view of the document that highlights sections that may be of interest to the user based upon the user profile or redact certain sections of the document based upon the user profile that might not be of interest to the user. The personalized presentation of the document can be generated based identified document components and the user profile by a process that utilizes a comparison module that is trained using the user profile as an input. The personalized presentation can then be generated using a reverse-feeding dictionary. In one example, the document analysis engine 116 can utilize a comparison module trained on a supervised machine learning model, such as Linear regression or Support vector machines, which can take in as input a number of data factors and return a singular value/vector. In this scenario, the model is fed in the various profile sources that comprise the user data 117 to generate a content tag. The model will also provide a reverse-feeding dictionary to allow retrieving which factor ranges are relevant to a certain tag.

Additionally, the document analysis engine 116 can tune the personalized presentation based upon a verbosity level that is either identified for the user or selected by the user. The more verbose a verbosity level, the more of the document that is presented within the personalized presentation. The less verbose a verbosity level, the less verbose of a personalized presentation that is presented to the user.

The data stored in the data store 113 includes, for example, user data 117, document data 119, and potentially other data. The user data 117 can include data associated with a user account, such as a user profile 122, user documents, and other user profile information. User data 117 can include access settings, such as authentication credentials, delegation settings (e.g., information about other users who can be provided access to the user data 117 of a particular user), mail and document retention rules and/or policies, and/or other geographic access restrictions or limitations (e.g., information about certain locations and/or networks from which user data 117 can be accessed). User data 117 can also include other account settings, such as biographical or demographic information about a user, password reset information, multi-factor authentication settings, and other data related to a user account as can be appreciated. User data 117 can further include a role within an organizational hierarchy. For example, a role can identify the user as a supervisor for certain other users and/or as reporting to another user in an organization.

User data 117 can further include a history of documents, web pages, or other content that the user has previously accessed. The user data 117 can further include a history of documents, web pages, or other content that the user has authored, distributed, endorsed, or otherwise indicated an interest.

The user profile 122 can be generated by the document analysis engine 116 based upon the history of the user, the role of the user within an organization, a job title of the user, how senior the user is within an organization, and other user profile data. The user profile 122 can also include a verbosity level that is selected by or on behalf of a user. From the user profile 122, the document analysis engine 116 can then generate personalized presentations of documents for the user.

For example, a user that is within the same organization or group as another user sending or creating a document might be shown the full and unedited version of the document. A user from a different organization of group as another use sending or creating the document might be shown a redacted version of the document. In some scenarios, the document analysis engine 116 can generate contextual hints so that the user receiving the document can more easily consume or follow the content of the document. For example, a developer in the same team or business unit as another developer authoring a document might be shown the document without contextual hints or summarization. A developer in a different team or business unit as a developer authoring might be shown the document with contextual hints generated by the document analysis engine 116.

The document analysis engine 116 can generate contextual hints by generating a summary of the classified components of the document. The document analysis engine 116 can generate a summary of a portion of the document that is capped at a certain number of words. The document analysis engine 116 can display the summary as a contextual hint to the user in a user interface that is presented alongside or overlaid onto the document by the document analysis engine 116.

Document data 119 can comprise information about documents that are distributed to users via the document analysis engine 116. The document data 119 can comprise a document file 123 corresponding to a particular document, the document components 125 that are identified or classified by the document analysis engine 116, and a document representation 127 that can be generated for a particular user. The document file 123 can represent a document in a proprietary or open document format, images, video, or other types of content that can be sent or distributed to users within an enterprise.

The document components 125 can represent the components of a document that are identified by the document analysis engine 116 in analyzing the document. The document components 125 can be identified and tagged by the document analysis engine 116 using a document analysis algorithm. First, the document analysis engine 116 can identify components of a document based upon keywords that appear in headings, for example. An abstract, body, discussion, conclusion, executive summary, and other components can be identified in this way. Additionally, a sequence-to-class deep learning model can be utilized that takes as an input a sequence of text and returns a tag or series of tags that best represent the sequence of text.

The document representation 127 can be the personalized presentation of a document that is generated by the document analysis engine 116. The personalized presentation can be specific to a user based upon the user profile 122 of the user. The personalized presentation can comprise a version of the document that comprises redactions, annotations, contextual hints, summaries of document components 125, translations of document components 125, and other customizations and personalizations generated by the document analysis engine 116.

The client device 106 is representative of a plurality of client devices that can be coupled to the network 109. The client device 106 can comprise, for example, a processor-based system such as a computer system. Such a computer system can be embodied in the form of a desktop computer, a laptop computer, a personal digital assistant, a cellular telephone, a smartphone, a set-top box, a music player, a web pad, a tablet computer system, a game console, an electronic book reader, or any other device with like capability. The client device 106 can include a display 128 that comprises, for example, one or more devices such as liquid crystal display (LCD) displays, gas plasma-based flat panel displays, organic light emitting diode (OLED) displays, LCD projectors or other types of display devices.

The client device 106 can execute various applications, such as a viewer application 129, a management component 131, and/or other components. In this respect, the client device 106 represents a device executing a management component 131 and/or a device that is enrolled within a device management framework associated with an enterprise. A client device 106 represents a device associated with a user who can be external to the enterprise or a device that is not enrolled within the device management framework of the enterprise. The viewer application 129 can obtain and render a document representation 127 to generate user interfaces 135 based upon the document representation 127 transmitted from the document analysis engine 116, the management service 115 and/or any other process or server. The viewer application 129 can include, for example, a browser, a special purpose application configured to facilitate the browsing of documents available via the data store 113, an email client, a document viewer, or any other type of application that can render a document representation 127. A user interface 135 can be rendered by the viewer application 129 from a document representation 127 that corresponds to a particular user document or content obtained from the document analysis engine 116.

The management component 131 can be executed on the client device 106 to oversee, monitor, and/or manage at least a portion of the resources for the client device 106. The management component 131 can be executed by the client device 106 automatically upon startup of the client device 106. Additionally, the management component 131 may run as a background process in the client device 106. In other words, the management component 131 may execute and/or run without user intervention. Additionally, the management component 131 may communicate with the management service 115 to facilitate the management of the client device 106 by the management service 115.

Next, a general description of the operation of the various components of the networked environment 100 is provided. The document analysis engine 116 can perform various functions, which can be integrated into a single application or service. Alternatively, the functionality of the document analysis engine 116 can also be separated into multiple applications or services. First, the document analysis engine 116 can obtain a request from a user of an enterprise to obtain a document or content that the enterprise has determined should be analyzed by the document analysis engine 116 to identify content for which a personalized document representation 127 should be generated. Such a request can be initiated by a user interface, such as a web page. The request can also be initiated by an email client for an attachment or a document to which a message linked. The request can be initiated through any viewer application 129 executed by the client device 106.

The document analysis engine 116 can generate a user profile 122 for the user. The user profile 122 can be generated or updated each time the user accesses a document or periodically generated or updated asynchronously with the user accessing a document. The user profile 122 can be a dynamic profile tailored to the user and trained on various data sources associated with a user. These data sources can include an identity of the user within a user directory or identity provider service, an entity or company with which the user is associated, a job function or job description of the user, a group or business unit to which the user belongs, or other demographic or identifying information about the user. The user profile 122 can also be based upon an email archive of the user that includes emails that are sent or received by the user. The user profile 122 can also include browsing history of the user indicating content that the user has previously read, liked, or otherwise indicated an interest in the content. The user profile 122 can further include content that the user has authored or published. The reading, browsing, and other user activity from which a user profile 122 can be generated can be obtained by the management service 115 that is tasked with managing devices of the user as well as the user's access to enterprise resources.

The user profile 122 can also include a verbosity level that is selected by or on behalf of the user. The verbosity level can be automatically selected by the user based upon a reading history of the user. In one example, the management service 115 can determine an amount of time the user has spend reading previous documents that were accessed by the user. If the user spends less than an average amount of time reading previous documents accessed by the user, a verbosity level associated with less verbosity can be selected because that indicates that the user spends less time reading documents and may be less interested in reading all of a document. In addition to tracking the amount of time the user has spent reading previous documents, the management service 115 can also determine an amount of time the user has spent reading documents in various categories to identify content categories in which the user is interested. If the user spends more than an average amount of time reading content in a particular category, a verbosity level associated with more verbosity can be selected for a document in the same category because that indicates that the user might be more interested in reading documents in the category.

The document analysis engine 116 can then perform a document analysis based on a document that is being accessed by the user. In one example, the document analysis engine 116 can analyze a text-based document to identify its various components, such as an abstract, executive summary, main discussion, conclusion, technical details, or other components that the document analysis engine 116 can be trained to analyze. In one example, the document analysis engine 116 can be trained on a corpus of enterprise documents associated with the user data 117 of the user or a population of users.

The document analysis engine 116 can utilize a sequence-to-class deep learning model can be utilized that takes as an input a sequence of text and returns a tag or series of tags that best represent the sequence of text. The document analysis engine 116 can generate summaries of the document components 125 and/or contextual hints associated with the document components 125 that can be rendered in a user interface 135 on the client device 106.

The document analysis engine 116 can then generate a personalized presentation of the document based upon the user profile and the document analysis that was performed. When a user accesses a document through a viewer application 129 or in a user interface generated on another device, a document representation 127 that incorporates the personalized presentation can be provided to the user. The personalized presentation can highlight sections of the document that might be of interest to the user based upon the user profile 122. The personalized presentation can also adjust presentation of the document according to a verbosity level chosen by or on behalf of the user. A full verbosity level can present the entire document, whereas an abbreviated verbosity level can present summaries or contextual hints of the various document components 125.

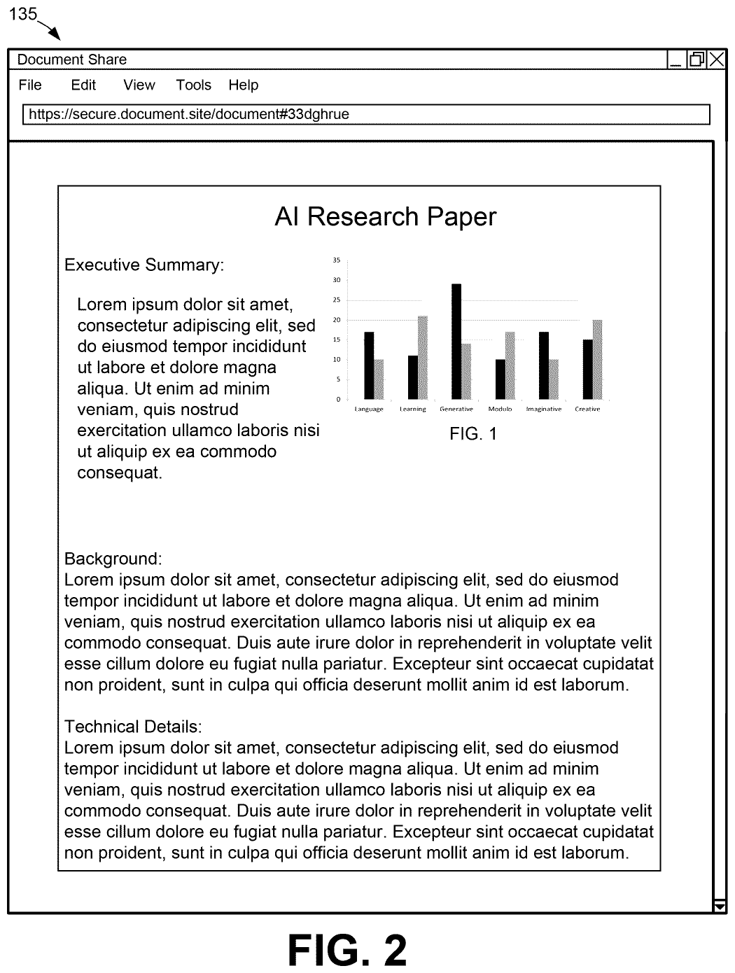

The various implementations are discussed in further detail after discussion of an example of the document analysis engine 116 in operation as illustrated in FIGS. 2-4.

Referring next to FIG. 2, shown is an example user interface 135 that can be rendered by a viewer application 129 executed by a client device 106 according to various embodiments of the disclosure. The user interface 135 corresponds to a document representation 127 rendered by the viewer application 129 in response to obtaining a document or other content via the document analysis engine 116. In one example, the document analysis engine 116 can provide a modified version of content to a viewer application 129 that serves content via a web server, and the viewer application 129 can be a web browser that renders the user interface 135 in this instance. As shown in the example of FIG. 2, the document representation 127, when rendered by a viewer application 129, causes at least a portion of the content of a particular document to be displayed within the user interface 135.

As also shown in FIG. 2, the document representation 127 can represent content that is unmodified or unredacted by the document analysis engine 116. In this scenario, the viewing user for whom the content is rendered might have selected a full verbosity level such that documents are presented in their entireties in the user interface 135. Alternatively, the example of FIG. 2 can also illustrate a scenario where the document analysis engine 116 is not utilized according to examples of the disclosure. As another example, the document analysis engine 116 can determine, based upon the user profile 122 of the user, that the user should be presented with the full document because the user has the same job function or is a member of the same group as the author of the document in the user interface 135.

Additionally, the full document can be presented if the user profile 122 indicates that the user has expressed a high degree of interest in documents similar to the one presented in the user interface 135 or others documents that have similar content.

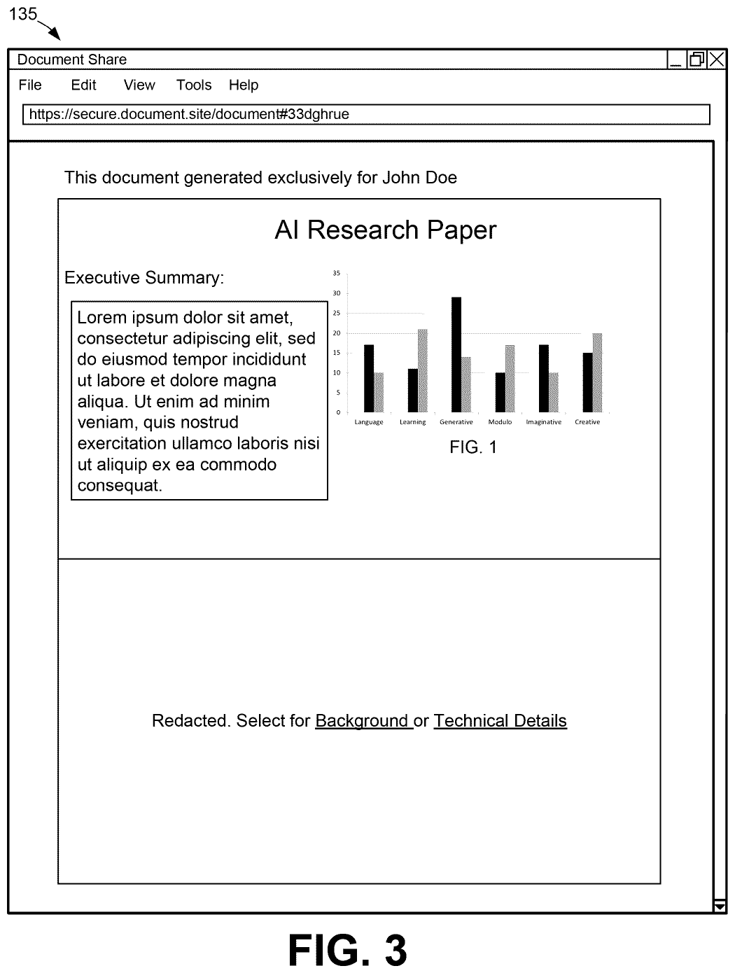

Continuing the example of FIG. 2, reference is now made to FIG. 3, which illustrates another example user interface 135 that can be rendered by a viewer application 129 executed by a client device 106 according to various embodiments of the disclosure. The user interface 135 shown in FIG. 3 also corresponds to the document representation 127 rendered by the viewer application 129 in response to modification of the content requested by the user. The content can be redacted or modified by the document analysis engine 116 according to a user profile 122 and the content type detected within the document by the document analysis engine 116. However, the document analysis engine 116 can identify and classify the document components 125 of the document so that a personalized presentation of the document can be presented to other users or so that the presentation shown in FIG. 3 can be modified should the user select a different verbosity level of the document.

In the example of FIG. 3, the document analysis engine 116 can generate a personalized presentation of the document of FIG. 2 that can be rendered by the viewer application 129. A document representation 127 can be generated that modifies and/or redacts certain document components 125 that are identified by the document analysis engine 116 according to various examples.

In the same shown in FIG. 3, the document analysis engine 116 can determine based upon the user profile 122 that the user is less likely to read the document if the document is presented in full. Additionally, the document analysis engine 116 can also determine based upon the user profile 122 that certain document components 125 should be highlighted, such as the executive summary.

Accordingly, to present the document representation 127 shown in FIG. 3, the document analysis engine 116 can create or access a user profile 122 of the user. As noted above, the user profile 122 can be based upon the reading or browsing history of the user, an authorship history of the user, the role of the user within an organization, a job title of the user, how senior the user is within an organization, and other user profile data. The user profile 122 can also include a verbosity level that is selected by or on behalf of a user. From the user profile 122, the document analysis engine 116 can then generate personalized presentations of documents for the user.

For example, a user that is within the same organization or group as another user sending or creating a document might be shown the full and unedited version of the document. A user from a different organization of group as another use sending or creating the document might be shown a redacted version of the document. In some scenarios, the document analysis engine 116 can generate contextual hints so that the user receiving the document can more easily consume or follow the content of the document. For example, a developer in the same team or business unit as another developer authoring a document might be shown the document without contextual hints or summarization. A developer in a different team or business unit as a developer authoring might be shown the document with contextual hints generated by the document analysis engine 116.

The document analysis engine 116 can also classify, tag, or identify the document components 125 of the document being accessed by the user. The document components 125 can represent the components of a document that are identified by the document analysis engine 116 in analyzing the document. The document components 125 can be identified and tagged by the document analysis engine 116 using a document analysis algorithm. First, the document analysis engine 116 can identify components of a document based upon keywords that appear in headings, for example. An abstract, body, discussion, conclusion, executive summary, and other components can be identified in this way. Additionally, a sequence-to-class deep learning model can be utilized that takes as an input a sequence of text and returns a tag or series of tags that best represent the sequence of text.

Accordingly, based upon the analysis of the user profile 122 and of the document components 125, the document analysis engine 116 can generate the personalized presentation of the document, or a document representation 127. The document representation 127 can be the personalized presentation of a document that is generated by the document analysis engine 116. The personalized presentation can be specific to a user based upon the user profile 122 of the user. The personalized presentation can comprise a version of the document that comprises redactions, annotations, contextual hints, summaries of document components 125, translations of document components 125, and other customizations and personalizations generated by the document analysis engine 116.

In the example of FIG. 3, the personalized presentation has highlighted the executive summary and has redacted other sections of the document, such as the background and technical details. These components can still be accessed by the user in the user interface 135 by interacting with the UI elements that reveal the document components 125. However, to incentivize or facilitate the user to read the document at least in part, the personalized presentation based upon the user profile 122 can present an abbreviated, summarized, or redacted version of the document as shown in FIG. 3.

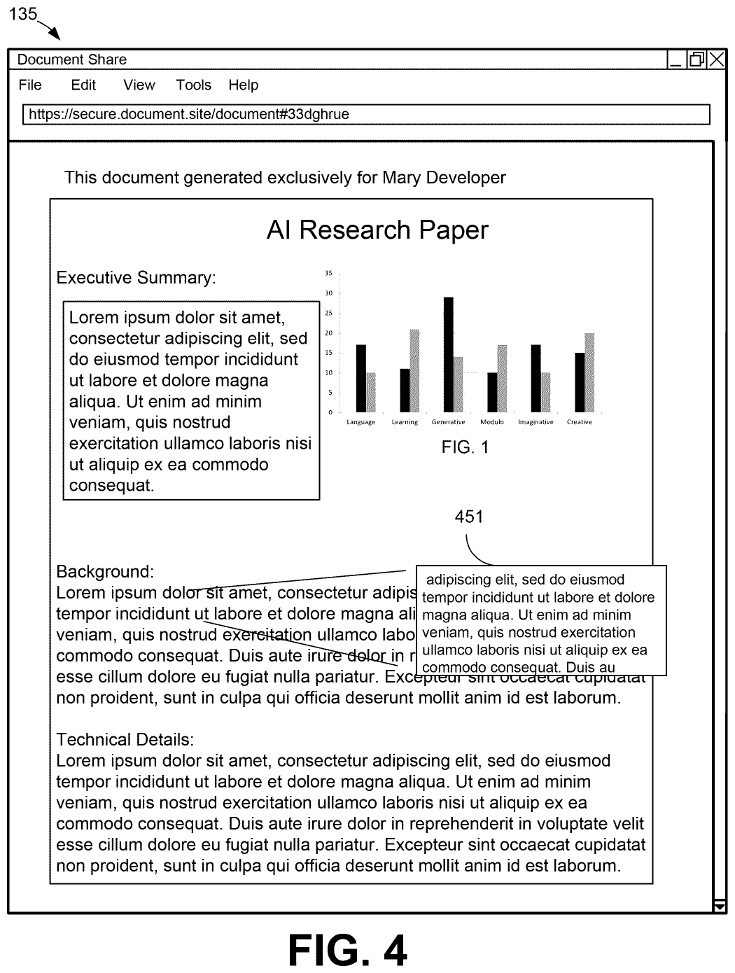

Continuing the example of FIG. 3, reference is now made to FIG. 4, which illustrates another example user interface 135 that can be rendered by a viewer application 129 executed by a client device 106 according to various embodiments of the disclosure. The user interface 135 shown in FIG. 3 also corresponds to the document representation 127 rendered by the viewer application 129 in response to modification of the content requested by the user. As shown in the example of FIG. 4, the document analysis engine 116 can generate contextual hints that can be rendered along with the document. The contextual hint, shown at UI element 451, can be generated by the document analysis engine 116 after classification of the document components 125 of the document. The decision to render the contextual hint for the particular user can be based upon the analysis of the user profile 122.

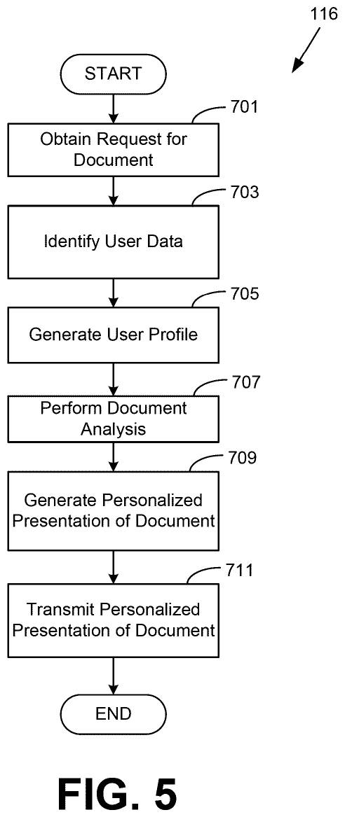

Referring next to FIG. 5, shown is a flowchart that provides one example of the operation of a portion of the document analysis engine 116 according to various embodiments. It is understood that the flowchart of FIG. 5 provides merely an example of the many different types of functional arrangements that can be employed to implement the operation of the portion of the document analysis engine 116 as described herein. As an alternative, the flowchart of FIG. 5 can be viewed as depicting an example of elements of a method implemented in the computing environment 103 (FIG. 1) according to one or more embodiments.

Beginning with box 701, the document analysis engine 116 obtains a request for a document on behalf of a user of the enterprise. In some embodiments, the user may not be associated with an enterprise or an organization but may rather be viewing a document or content through a portal in which the document analysis engine 116 can identify the user and corresponding user data user data 117 associated with the user. The request for the document can be made via a viewer application 129. The viewer application 129 can obtain and render a document representation 127 to generate user interfaces 135 based upon the document representation 127 transmitted from the document analysis engine 116, the management service 115 and/or any other process or server. The viewer application 129 can include, for example, a browser, a special purpose application configured to facilitate the browsing of documents available via the data store 113, an email client, a document viewer, or any other type of application that can render a document representation 127. A user interface 135 can be rendered by the viewer application 129 from a document representation 127 that corresponds to a particular user document or content obtained from the document analysis engine 116.

At box 703, the document analysis engine 116 can user data 117 associated with the user. The user data 117 can include information about the user's role within an enterprise or hierarchy, reading habits of the user, browsing history of the user, authorship history of the user, the user's interests in other documents or contents, files and documents associated with the user in a document storage system, or other user data or user profile data.

At step 705, the document analysis engine 116 can generate a user profile 122 based upon the user data 117. The user profile 122 can be generated by the document analysis engine 116 based upon the history of the user, the role of the user within an organization, a job title of the user, how senior the user is within an organization, and other user profile data. The user profile 122 can also include a verbosity level that is selected by or on behalf of a user. From the user profile 122, the document analysis engine 116 can then generate personalized presentations of documents for the user.

For example, a user that is within the same organization or group as another user sending or creating a document might be shown the full and unedited version of the document. A user from a different organization of group as another use sending or creating the document might be shown a redacted version of the document. In some scenarios, the document analysis engine 116 can generate contextual hints so that the user receiving the document can more easily consume or follow the content of the document. For example, a developer in the same team or business unit as another developer authoring a document might be shown the document without contextual hints or summarization. A developer in a different team or business unit as a developer authoring might be shown the document with contextual hints generated by the document analysis engine 116. In some examples, the user profile 122 can be retrieved rather than generated each time a user requests a document via the document analysis engine 116.

At step 707, the document analysis engine 116 can perform a document analysis of the document. The document analysis engine 116 can perform a document analysis based on a document that is being accessed by the user. In one example, the document analysis engine 116 can analyze a text-based document to identify its various components, such as an abstract, executive summary, main discussion, conclusion, technical details, or other components that the document analysis engine 116 can be trained to analyze. In one example, the document analysis engine 116 can be trained on a corpus of enterprise documents associated with the user data 117 of the user or a population of users.

The document analysis engine 116 can utilize a sequence-to-class deep learning model can be utilized that takes as an input a sequence of text and returns a tag or series of tags that best represent the sequence of text. The document analysis engine 116 can generate summaries of the document components 125 and/or contextual hints associated with the document components 125 that can be rendered in a user interface 135 on the client device 106.

At step 709, the document analysis engine 116 can generate a personalized presentation of the document, or generate the document representation 127. The document analysis engine 116 can then generate a personalized presentation of the document based upon the user profile and the document analysis that was performed. When a user accesses a document through a viewer application 129 or in a user interface generated on another device, a document representation 127 that incorporates the personalized presentation can be provided to the user. The personalized presentation can highlight sections of the document that might be of interest to the user based upon the user profile 122. The personalized presentation can also adjust presentation of the document according to a verbosity level chosen by or on behalf of the user. A full verbosity level can present the entire document, whereas an abbreviated verbosity level can present summaries or contextual hints of the various document components 125.

At step 711, the personalized presentation of the document can be provided to the user. The personalized presentation can be provided to a viewer application 129 on a client device 106 in various examples. Thereafter, the process can proceed to completion.

Although the management service 115, the document analysis engine 116, and other various systems described herein can be embodied in software or code executed by general purpose hardware as discussed above, as an alternative, the same may also be embodied in dedicated hardware or a combination of software/general purpose hardware and dedicated hardware. If embodied in dedicated hardware, each can be implemented as a circuit or state machine that employs any one of or a combination of a number of technologies. These technologies may include, but are not limited to, discrete logic circuits having logic gates for implementing various logic functions upon an application of one or more data signals, application specific integrated circuits (ASICs) having appropriate logic gates, field-programmable gate arrays (FPGAs), or other components, etc. Such technologies are generally well known by those skilled in the art and, consequently, are not described in detail herein.

The flowchart of FIG. 5 shows an example of the functionality and operation of an implementation of portions of the document analysis engine 116. If embodied in software, each block may represent a module, segment, or portion of code that comprises program instructions to implement the specified logical function(s). The program instructions can be embodied in the form of source code that comprises human-readable statements written in a programming language or machine code that comprises numerical instructions recognizable by a suitable execution system such as a processor 803 in a computer system or other system. The machine code can be converted from the source code, etc. If embodied in hardware, each block may represent a circuit or a number of interconnected circuits to implement the specified logical function(s).

Although the flowchart of FIG. 5 shows a specific order of execution, it is understood that the order of execution may differ from that which is depicted. For example, the order of execution of two or more blocks can be scrambled relative to the order shown. Also, two or more successive blocks shown in FIG. 5 can be executed concurrently or with partial concurrence. Further, in some embodiments, one or more of the blocks shown in FIG. 5 can be skipped or omitted. In addition, any number of counters, state variables, warning semaphores, or messages might be added to the logical flow described herein, for purposes of enhanced utility, accounting, performance measurement, or providing troubleshooting aids, etc. It is understood that all such variations are within the scope of the present disclosure.

Also, any logic or application described herein, including the document analysis engine 116, that comprises software or code can be embodied in any non-transitory computer-readable medium for use by or in connection with an instruction execution system such as, for example, a processor 803 in a computer system or other system. In this sense, the logic may comprise, for example, statements including instructions and declarations that can be fetched from the computer-readable medium and executed by the instruction execution system. In the context of the present disclosure, a “computer-readable medium” can be any medium that can contain, store, or maintain the logic or application described herein for use by or in connection with the instruction execution system.

The computer-readable medium can comprise any one of many physical media such as, for example, magnetic, optical, or semiconductor media. More specific examples of a suitable computer-readable medium would include, but are not limited to, magnetic tapes, magnetic floppy diskettes, magnetic hard drives, memory cards, solid-state drives, USB flash drives, or optical discs. Also, the computer-readable medium can be a random access memory (RAM) including, for example, static random access memory (SRAM), dynamic random access memory (DRAM), or magnetic random access memory (MRAM). In addition, the computer-readable medium can be a read-only memory (ROM), a programmable read-only memory (PROM), an erasable programmable read-only memory (EPROM), an electrically erasable programmable read-only memory (EEPROM), or other type of memory device.

Further, any logic or application described herein, including the document analysis engine 116, can be implemented and structured in a variety of ways. For example, one or more applications described can be implemented as modules or components of a single application. Further, one or more applications described herein can be executed in shared or separate computing devices or a combination thereof. For example, a plurality of the applications described herein may execute in the same computing device 800 and/or client device 106, or in multiple computing devices in the same computing environment 103. Additionally, it is understood that terms such as “application,” “service,” “system,” “engine,” “module,” and so on can be interchangeable and are not intended to be limiting.

Disjunctive language such as the phrase “at least one of X, Y, or Z,” unless specifically stated otherwise, is otherwise understood with the context as used in general to present that an item, term, etc., can be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

It is emphasized that the above-described embodiments of the present disclosure are merely possible examples of implementations set forth for a clear understanding of the principles of the disclosure. Many variations and modifications can be made to the above-described embodiments without departing substantially from the spirit and principles of the disclosure. All such modifications and variations are intended to be included herein within the scope of this disclosure and protected by the following claims.

What is claimed is:

1. A non-transitory computer-readable medium embodying a program executable in a computing device, the program, when executed by the computing device, being configured to cause the computing device to at least:
identify a user in a user directory;
generate a user profile based upon an analysis of an email archive of the user, a group membership of the user within the user directory, a calendar archive of the user, or historical tracking data associated with the user;
identify a document accessible to the user;
tag a plurality of document components from the document based upon an analysis of a content of the document; and
generate a personalized presentation of the document based upon the plurality of the document components and the user profile.

2. The non-transitory computer-readable medium of claim 1, wherein the program generates the personalized presentation of the document by causing the computing device to at least:
identify a verbosity level based upon the historical tracking data, wherein the historical tracking data further comprises a reading profile of the user associated with a plurality of previous documents; and
redacting at least one document component from the document based upon the verbosity level.

3. The non-transitory computer-readable medium of claim 1, wherein the program generates the personalized presentation of the document by causing the computing device to at least:
generate at least one contextual hint corresponding to a document component from the document; and
cause the at least one contextual hint to be rendered in the personalized presentation alongside the document component.

4. The non-transitory computer-readable medium of claim 1, wherein the program generates the personalized presentation of the document by causing the computing device to at least:
generate a verbosity user interface component facilitating adjustment of the verbosity of the personalized presentation of the document; and
in response to a change in a selected verbosity level, causing the personalized presentation of the document to be updated.

5. The non-transitory computer-readable medium of claim 1, wherein the program generates the user profile based upon a further analysis of a plurality of documents associated with the user in a document archive.

6. The non-transitory computer-readable medium of claim 1, wherein the program tags the plurality of document components from the document based upon the analysis of a content of the document by utilizing a sequence-to-class deep learning model that takes a sequence of text as an input and returns a tag the represents the sequence of text.

7. The non-transitory computer-readable medium of claim 1, wherein the personalized presentation of the document based upon the plurality of the document components and the user profile is generated by a comparison module that is trained using the user profile as an input and the personalized presentation is generated using a reverse-feeding dictionary.

8. A system, comprising:
at least one computing device;
at least one application executed by the at least one computing device, the at least one application, when executed, causing the at least one computing device to at least:
identify a user in a user directory;
generate a user profile based upon an analysis of an email archive of the user, a group membership of the user within the user directory, a calendar archive of the user, or historical tracking data associated with the user;
identify a document accessible to the user;
tag a plurality of document components from the document based upon an analysis of a content of the document; and
generate a personalized presentation of the document based upon the plurality of the document components and the user profile.

9. The system of claim [symbol] wherein the at least one application generates the personalized presentation of the document by causing the computing device to at least:
identify a verbosity level based upon the historical tracking data, wherein the historical tracking data further comprises a reading profile of the user associated with a plurality of previous documents; and
redacting at least one document component from the document based upon the verbosity level.

101. The system of claim 8, wherein the at least one application generates the personalized presentation of the document by causing the computing device to at least:
generate at least one contextual hint corresponding to a document component from the document; and
cause the at least one contextual hint to be rendered in the personalized presentation alongside the document component.

11. The system of claim 8, wherein the at least one application generates the personalized presentation of the document by causing the computing device to at least:
generate a verbosity user interface component facilitating adjustment of the verbosity of the personalized presentation of the document; and
in response to a change in a selected verbosity level, causing the personalized presentation of the document to be updated.

12. The system of claim 8, wherein the at least one application generates the user profile based upon a further analysis of a plurality of documents associated with the user in a document archive.

13. The system of claim 8, wherein the at least one application tags the plurality of document components from the document based upon the analysis of a content of the document by utilizing a sequence-to-class deep learning model that takes a sequence of text as an input and returns a tag the represents the sequence of text.

14. The system of claim [symbol] wherein the personalized presentation of the document based upon the plurality of the document components and the user profile is generated by a comparison module that is trained using the user profile as an input and the personalized presentation is generated using a reverse-feeding dictionary.

15. A method, comprising:
obtaining, by at least one computing device, a request to provide a document to a user associated with a user account;
identify a user in a user directory;
generate a user profile based upon an analysis of an email archive of the user, a group membership of the user within the user directory, a calendar archive of the user, or historical tracking data associated with the user;
identify a document accessible to the user;
tag a plurality of document components from the document based upon an analysis of a content of the document; and
generate a personalized presentation of the document based upon the plurality of the document components and the user profile.

16. The method of claim [symbol] wherein generating the personalized presentation of the document further comprises:
identify a verbosity level based upon the historical tracking data, wherein the historical tracking data further comprises a reading profile of the user associated with a plurality of previous documents; and
redacting at least one document component from the document based upon the verbosity level.

17. The method of claim 15, wherein generating the personalized presentation of the document further comprises:
generate at least one contextual hint corresponding to a document component from the document; and
cause the at least one contextual hint to be rendered in the personalized presentation alongside the document component.

18. The method of claim 15, wherein generating the personalized presentation of the document further comprises:
generate a verbosity user interface component facilitating adjustment of the verbosity of the personalized presentation of the document; and
in response to a change in a selected verbosity level, causing the personalized presentation of the document to be updated.

19. The method of claim 15, wherein generating the user profile is based upon a further analysis of a plurality of documents associated with the user in a document archive.

20. The method of claim 15, wherein the personalized presentation of the document based upon the plurality of the document components and the user profile is generated by a comparison module that is trained using the user profile as an input and the personalized presentation is generated using a reverse-feeding dictionary.
